(19) United States
(12) Patent Application Publication
(10) Pub. No.: US 2014/0108176 A1
(43) Pub. Date: Apr. 17, 2014

(54) Transferable File Position

(71) Applicants: Ann Russ, Mobile, AL (US); Samuel H. Russ, Mobile, AL (US)

(72) Inventors: Ann Russ, Mobile, AL (US); Samuel H. Russ, Mobile, AL (US)

(21) Appl. No.: 13/650,090

(22) Filed: Oct. 11, 2012

(51) Int. Cl. G06F 17/30; G06Q 30/06; G06F 15/16

(52) U.S. Cl. 705/26.1; 707/827; 707/E17.01

(57) ABSTRACT

A system for transferring file position between electronic media files is described. In one embodiment, for example, a consumer may download and read a sample of a complete book. Upon either full or partial completion of the sample, the consumer may wish to purchase the entire book. When the complete book is purchased, viewing of the book proceeds from the point where the sample was left off, allowing a seamless transition from sample to complete version.

### BACKGROUND OF THE INVENTION

Electronic media have flourished, replacing conventional media through their convenience and nearly instant access to a seemingly endless variety of titles and content. Downloading music, books, movies, and magazines has become quite common, and there is a clear motivation for content authors to continue to be able to charge for and monetize their content.

One common business model in electronic media is to provide a sample or a summary of a complete work (such as a book, magazine article, or musical work) for free or for reduced cost as an inducement for consumers to purchase subsequently the entire work. A common example is an online bookstore providing for free the first one or two chapters of a complete book.

One inconvenient aspect of this is that, once a sample has been read and the complete version purchased and downloaded, viewing of the complete work begins again at the beginning of the work. It is quite desirable, instead, that viewing of the complete work begin where the viewing of the summary or sample left off.

More broadly, in any situation where there are different versions of electronic media files, it is desirable, if an alternate version is subsequently downloaded or used, that the use or playback of the alternate version begin where the use or playback of the previous version left off.

Other documented systems, such as U.S. Pat. No. 7,229,067 to Riggs, certify completion of a file (or, in the context of the patent, a training unit) but do not describe a method for transferring partial-completion status to a different file Likewise, U.S. Pat. No. 7,155,451 to Torres describes arrangement of multiple URLs or files in a viewable sequence or “show” but does not describe transferring completion status in the middle of two or more files.

### BRIEF SUMMARY OF THE INVENTION

Use of words such as “sample” or “summary” throughout the rest of this document, including the Detailed Description, should not be interpreted as a limitation of the applicable scope of the present invention. Such words refer to a first version of an electronic media file. Similarly, use of words such as “complete” throughout the rest of the document should be regarded as non-limiting to scope and refer to a second version of an electronic media file.

In general, electronic media files are downloaded to computers. The media files may be books, works of music, movies, magazines, etc. Computers may be handheld devices, smart phones, tablets, desktop computers, etc. The computer runs software that can be used to purchase, download, process, and display media files.

Once a second version (e.g. “complete version”) of a media file is made available on a consumer's computer, the starting point of viewing, listening to, or otherwise using the second version is inferred or calculated from the first version (e.g. “sample version”), and viewing or using the second file begins at the calculated starting point rather than the beginning of the second file.

In one embodiment, the sample file, first, contains information designating the complete file and, second, contains information of a mapping from the summary file to the complete file. The designation of the complete file is used by the computer so that, if and when the complete file is downloaded, the process of mapping completion status from the sample file to the complete file can be carried out. The mapping indicates how the completion status (e.g. page number, file position, percentage completion) of the sample maps to a location in the complete file. Once the download of the complete file is finished, the mapping process is carried out and viewing of the complete file begins where the consumer left off in the sample file. For example, if the consumer read the first 12 pages of the sample, viewing of the complete book begins at page 12.

In another embodiment, the designation and mapping information is maintained at a server. A consumer downloads and views a sample file. At the moment the consumer decides to purchase the complete file, the completion status of the sample is transmitted to the server alongside the purchase request. The server processes the purchase request and transmits the complete file to the consumer's computer. In addition, and perhaps as part of the file download, the server transmits the location in the complete file where viewing is to begin.

In another embodiment, the designation and mapping information is contained in the complete file.

In another embodiment, the sample and complete files may be downloaded and viewed on different devices. The consumer views a sample on one device, perhaps a publicly accessible device at a bookstore, library, or kiosk, and elects to purchase it. The purchase request and completion status are transmitted to a server. The server processes the request and transmits the complete file to a computer designated by the consumer at the time of purchase, and also transmits the location in the complete file where viewing is to begin.

In another embodiment, either the sample or the complete file, or both, reside in a cloud-computing or network-based system. This is often the case if the electronic media file is large or if the viewing device has relatively little storage. In such cases, the “cloud” (or “network”) versions of the files are not downloaded to the consumer's computer but the viewing status, and the mapping between the sample version and the complete version, is maintained by (and at) the server. As with other embodiments, viewing or use of the complete file begins at the calculated starting point based on the completion of the sample file.

### BRIEF DESCRIPTION OF THE SEVERAL VIEWS OF THE DRAWINGS

FIG. 1 is an illustration of the process of switching from a sample file to a complete file, maintaining the viewing position in the process.

FIG. 2 is the process of switching from a sample file to a complete file using an embodiment in which the link to the complete file and the mapping information is in the sample file.

FIG. 3 is the process of switching from a sample file to a complete file using an embodiment in which the server maintains the link to the complete file and has the mapping information.

FIG. 4 is the process of switching from a sample file to a complete file using an embodiment in which the mapping information is contained in the complete file.

FIG. 5 is the process of switching from a sample file viewed on one device to a complete file downloaded to a different device using an embodiment in which the server maintains the link to the complete file and has the mapping information.

FIG. 6 is the process of switching from a sample file to a complete file in an embodiment in which the sample file, mapping information, and complete file all reside on a server and the media file is kept in cloud-based or network-based storage.

FIG. 7 is an example of an algorithm that might be used in an embodiment in which the link to the complete file and the mapping information is in the sample file.

FIG. 8 is an example of an algorithm that might be used in an embodiment in which the server maintains the link to the complete file and has the mapping information.

FIG. 9 is an example of an algorithm that might be used in an embodiment in which the mapping information is contained in the complete file.

FIG. 10 is an example of an algorithm that might be used in an embodiment in which the sample file, mapping information, and complete file all reside on a server and the media file is kept in cloud-based or network-based storage.

FIG. 11 is an optional additional step of asking the consumer if they wish to view the complete file at the point where viewing of the sample file left off.

### DETAILED DESCRIPTION OF THE INVENTION

The following description is presented in order to enable persons of ordinary skill in the art to make and use the invention. Various modifications to the disclosed embodiments will be readily apparent to persons of ordinary skill in the art, and the principles disclosed herein are applicable to other embodiments of the invention without departing from the spirit and scope of the present invention. Specifically, certain elements of the invention, such as the mapping information, can be maintained in a variety of locations (such as the consumer's computer, the sample file, the complete file, and the server). The invention explicitly discloses that there are numerous combinations of locations of invention elements, and all combinations are therefore disclosed herein.

Electronic media files are an increasingly popular mechanism for transferring information. Such media files may be, e.g., books, music, audio recordings, and video such as television shows or movies. These media files are viewed or otherwise used by consumers via a variety of devices including, e.g., computers, smart phones, tablets, laptop computers, kiosks, televisions, and set-top boxes. (Note that all methods of using or experiencing the content, including viewing and listening, are collectively referred to as “viewing”, and the device used for viewing is referred to as a “viewing device.”) The viewing device generally contains a human-viewable display and/or human-hearable speaker, storage to store the electronic media file, and a computer or microprocessor to coordinate or render to the display. In some alternate embodiments, such as when the amount of storage is limited or the electronic media file is large, the file is actually stored on a server and only the part of the media being viewed is transmitted to the viewing device. Finally, transfer of the files to viewing devices is accomplished over networks, which may include, e.g., wireless networks, cellular networks, and Ethernet.

Persons of ordinary skill in the art will appreciate that all manner and variety of computers, microprocessors, display devices, audio devices, storage, and networks may be employed to create viewing devices and associated infrastructure, and should be considered adequately disclosed.

A common business model for vendors who wish to sell electronic media files is to provide an abbreviated version of the media file for free or for reduced cost. The “abbreviation” may constitute only providing a portion of the file or may refer to a reduced-bitrate or reduced-resolution or other quality parameter. In any case, a free or reduced-cost version of the media file (often referred to below as a “sample file”) is provided as an inducement to buy or pay more for the complete version. In other circumstances, an abbreviated version of a file might be provided for the purposes of rapid downloading, with the intention of providing a more complete version if a user requests it. Both scenarios entail the presence of two versions of an electronic media file and the expression of desire on the part of the user to switch from the first version to the second version.

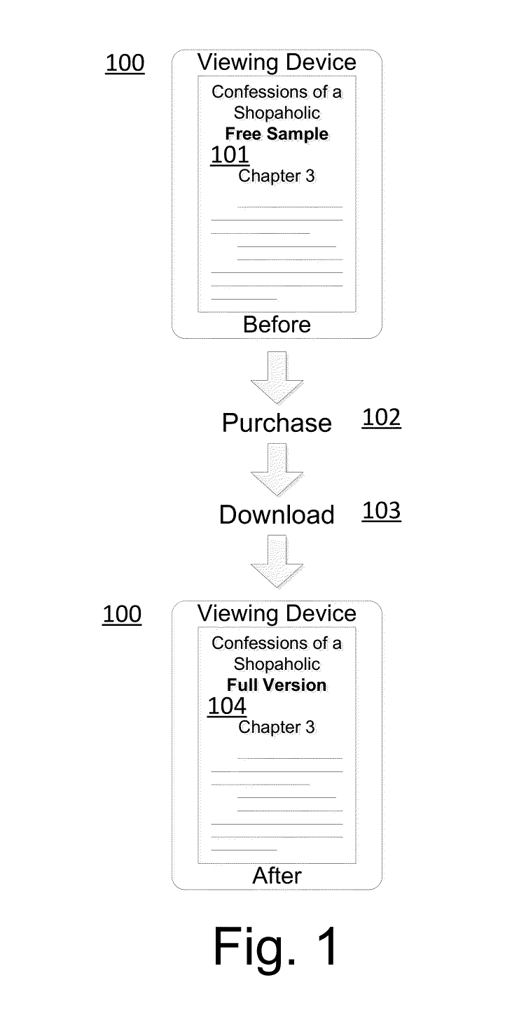

An example of such a scenario is illustrated in FIG. 1. A viewing device 100 displaying a sample file 101 is shown to a consumer. The consumer expresses a desire to purchase a complete file. The expression of desire is communicated via the user interface native to the consumer tablet, and encompasses both the hardware (e.g. buttons or touch screen) and software (e.g. user interface) of the tablet. The desire to purchase is communicated over a network (not shown) to a server (not shown). The server authorizes the purchase 102 of the complete file and downloads the file 103 to the tablet. When the complete file is downloaded, the viewing device 100 displays the complete file 104 at the point where the user stopped viewing the sample file. In FIG. 1, the point at which viewing of the sample file ends and viewing of the complete file begins is the beginning of Chapter 3 of a book.

Examples of consumer tablets capable of performing these functions include the Kindle manufactured by Amazon and the iPad manufactured by Apple.

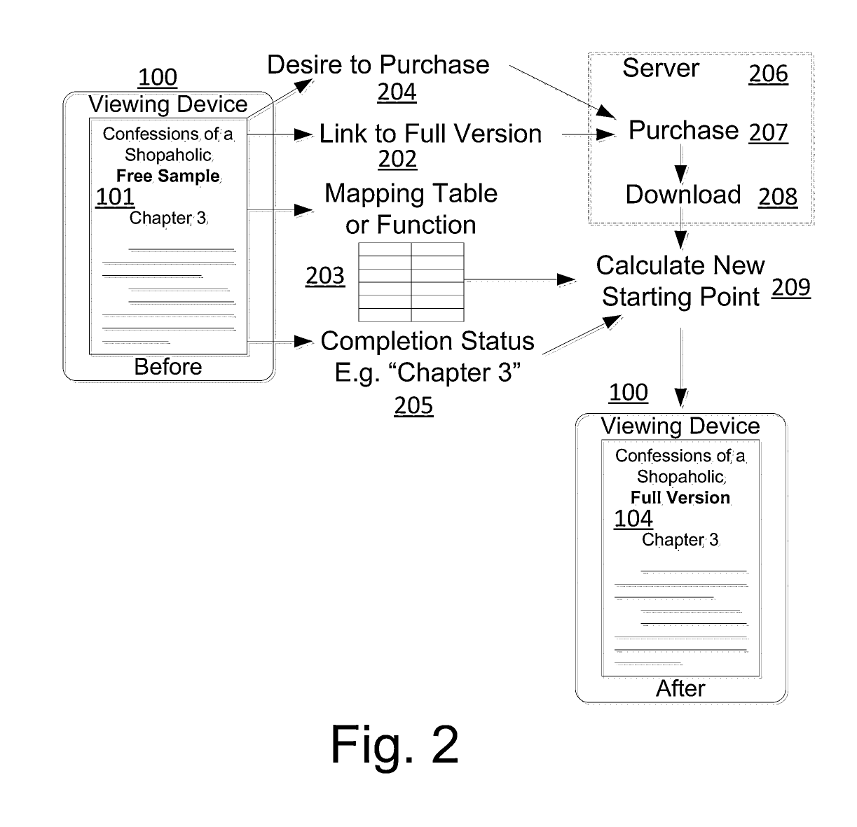

A more detailed example is illustrated in FIG. 2.

A viewing device 100 displaying a sample file 101 is shown to a consumer. As noted above, the file may be a book, movie, audio recording, etc.

There is a more complete version of the file available for purchase or download, and the sample file contains a link 202 that identifies the more complete version. The link may be a URL, a stock-keeping unit identifier, product code, UPC number, ISBN, or anything that identifies the complete version.

The sample file also contains a mapping table or mapping function 203. The purpose of the mapping information is to map the sample file into the complete file. In the case of a book, the mapping might specify, for example, which page of the complete file corresponds to each page of the sample file. In the case of a movie, it might specify the time offset. The mapping might be based on a file location, expressed in bytes. The mapping could be in the form of a table of entries (e.g. indexed by page number of the sample file) or could be a mapping function (e.g. each page of the complete book corresponds to the page of the sample file plus two). Note that the mapping might be a simple equality. For example, the page of the sample of the book might match the page of the complete version of the book, or the time offset of a sample video might match the time offset of the complete version of the video. In cases where the mapping is a form of equality, the mapping function might be inferred rather than explicitly stated. That is, the viewing device may simply initiate viewing of the complete version at the same point as where the sample file left off. In such cases, there is still a mapping function present in the process, but it is embedded in the operations performed by the viewing device.

At some point the consumer decides to “purchase” the complete version. Note that, in the instance of files that are made available for free, the decision is to “download” the complete version, but the terminology “purchase” is used here to describe that scenario. The desire to purchase the complete version 204 is expressed via some combination of user-interface hardware and software. For example, the hardware might comprise push buttons or a touch screen, and the software might comprise an operating system or executable script.

At the point the consumer decides to “purchase” the complete version, the viewing device makes note of the completion status 205, the point at which the file is currently being displayed. It might be a page number, a file offset, a time offset, or other indication of location or completion.

The fact that the consumer has requested the complete version is sent to a server 206 along with the link 202. The server might be identified by URL, domain-name, or IP address and port number. It might be a single server or a cluster of servers or a distributed “cloud” of servers. For example, the computer that processes the purchase request and the computer that manages the download may be separate computers, but are referred to herein collectively as “a server”.

In a significant alternate embodiment, the server 206 is a software entity residing on the viewing device 100 itself. In this embodiment, the sample file 101 and complete file 104 are both transmitted to the viewing device initially, and the request to purchase the complete file simply “unlocks” the complete file on the viewing device 100.

The server services the request to purchase the complete version 204 and uses the link information 202 to identify the complete file. The server 206 authorizes the purchase 207. For example, if payment is needed, the purchase process might require a credit card authorization or the vendor might have an account established with the consumer. The server 206 then downloads 208 the complete version 104 to the viewing device.

The viewing device uses the completion status 205 and the mapping information 203 to calculate the starting point of viewing the complete file 209. Thus when the viewing device 100 displays the complete file 104, it does so at the point where viewing the sample file left off.

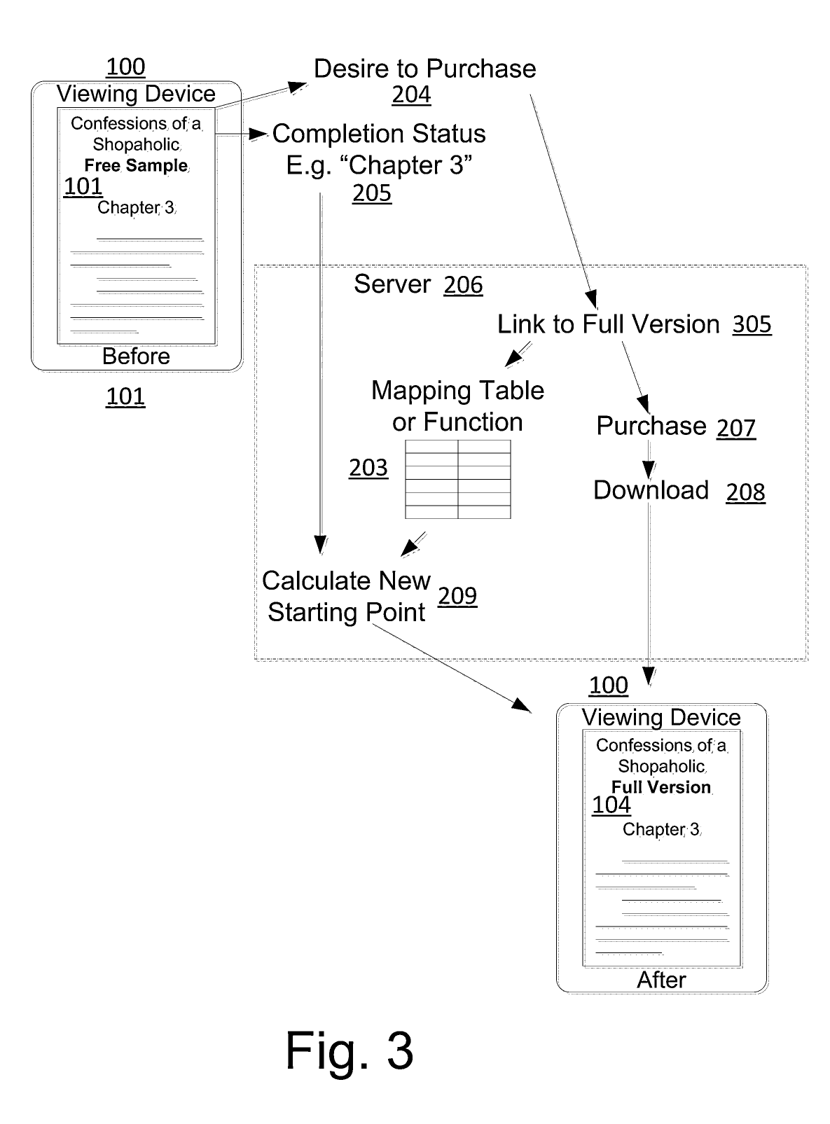

Another detailed example is illustrated in FIG. 3.

A viewing device 100 displaying a sample file 101 is shown to a consumer. At some point the consumer decides to “purchase” the complete version. The desire to purchase the complete version 204 is expressed via the viewing device's user interface. At the point the consumer decides to “purchase” the complete version, the viewing device makes note of the completion status 205, the point at which the file is currently being displayed.

The fact that the consumer has requested the complete version is sent to a server 206 along with the completion status 205.

There is a more complete version of the file available for purchase or download, and the server has a link 305 that identifies the more complete version. The link may be a URL, a stock-keeping unit identifier, product code, UPC number, ISBN, or anything that identifies the complete version. The server also has a mapping table or mapping function 203.

The server services the request to purchase the complete version 204 and uses the link information 305 to identify the complete file. The server 206 authorizes the purchase 207. The server 206 then downloads 208 the complete version 104 to the viewing device.

The server uses the completion status 205 and the mapping information 203 to calculate the starting point of viewing the complete file 209. This information is also transmitted to the viewing device 100, perhaps as part of the download or perhaps in a separate message.

Thus when the viewing device 100 displays the complete file 104, it does so at the point where viewing the sample file left off.

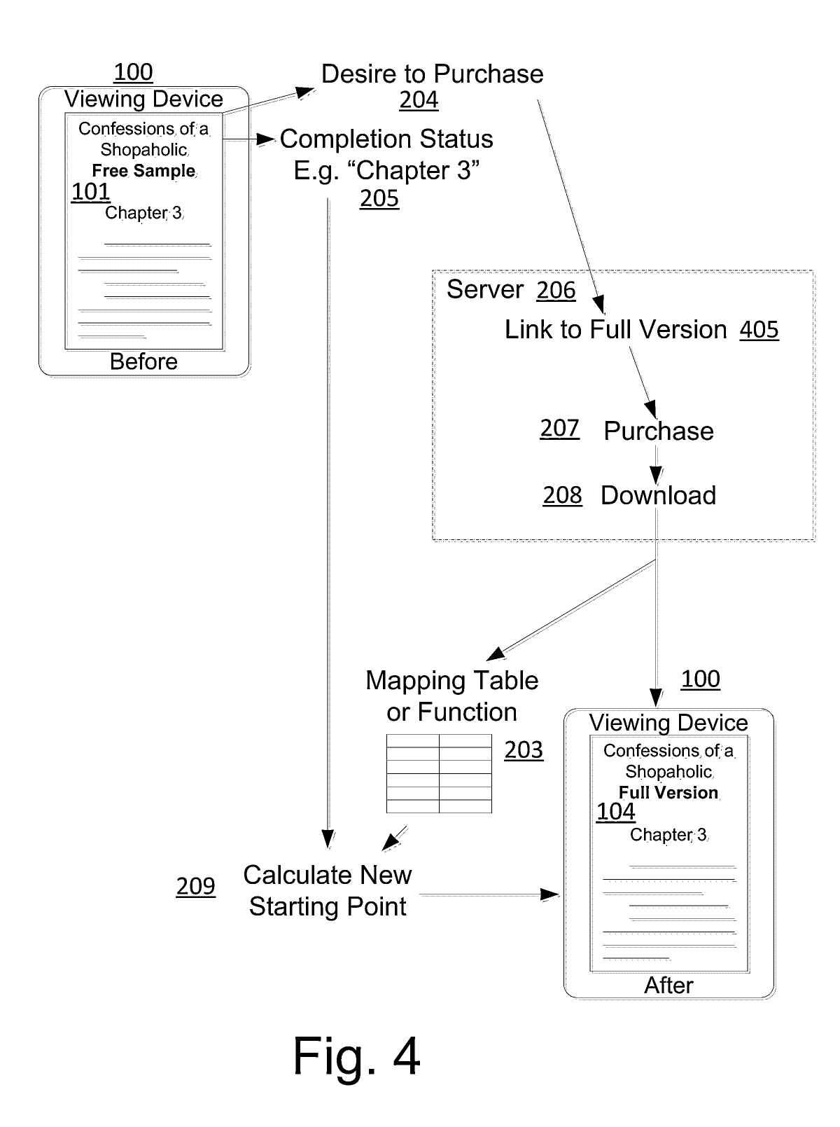

Another detailed example is illustrated in FIG. 4.

A viewing device 100 displaying a sample file 101 is shown to a consumer. At some point the consumer decides to “purchase” the complete version. The desire to purchase the complete version 204 is expressed via the viewing device's user interface. At the point the consumer decides to “purchase” the complete version, the viewing device makes note of the completion status 205, the point at which the file is currently being displayed.

The fact that the consumer has requested the complete version is sent to a server 206.

There is a more complete version of the file available for purchase or download, and the server has a link 405 that identifies the more complete version. The link may be a URL, a stock-keeping unit identifier, product code, UPC number, ISBN, or anything that identifies the complete version.

The server services the request to purchase the complete version 204 and uses the link information 405 to identify the complete file. The server 206 authorizes the purchase 207. The server 206 then downloads 208 the complete version 104 to the viewing device.

The server also has a mapping table or mapping function 203, and it transmits this information to the viewing device along with the complete-file download. This transmission may be part of the download or it may be in a separate transmission or message.

The viewing device uses the completion status 205 and the mapping information 203 to calculate the starting point of viewing the complete file 209. Thus when the viewing device 100 displays the complete file 104, it does so at the point where viewing the sample file left off.

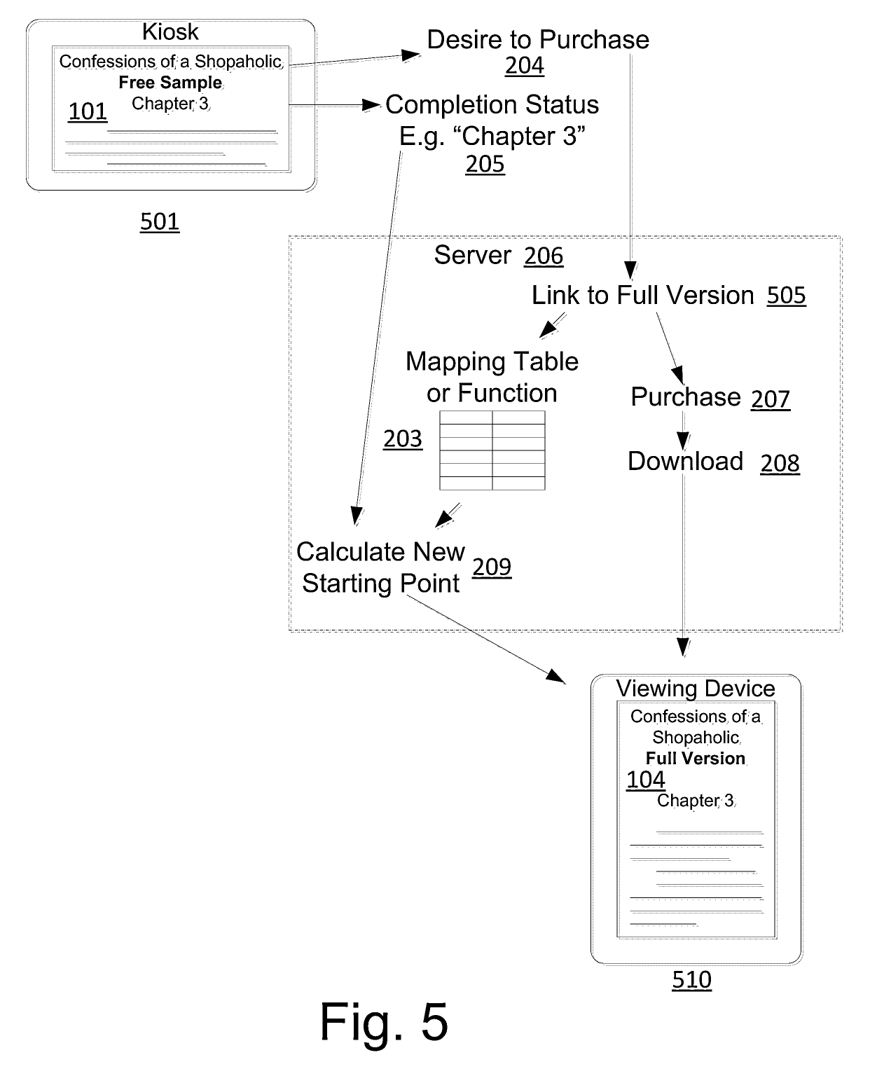

Another detailed example is illustrated in FIG. 5.

A kiosk 501 displaying a sample file 101 is shown to a consumer. The kiosk might be at a retail store or on display in a public area. It might be a web browser or website designed to offer samples for purchase. The kiosk might be the consumer's computer or some device owned or used by the consumer other than the viewing device.

At some point the consumer decides to “purchase” the complete version. The desire to purchase the complete version 204 is expressed via the kiosk's user interface. At the point the consumer decides to “purchase” the complete version, the kiosk makes note of the completion status 205, the point at which the file is currently being displayed.

The fact that the consumer has requested the complete version is sent to a server 206 along with the completion status 205.

There is a more complete version of the file available for purchase or download, and the server has a link 505 that identifies the more complete version. The link may be a URL, a stock-keeping unit identifier, product code, UPC number, ISBN, or anything that identifies the complete version. The server also has a mapping table or mapping function 203.

The server services the request to purchase the complete version 204 and uses the link information 305 to identify the complete file. The server 206 authorizes the purchase 207. The server 206 then downloads 208 the complete version 104 to the viewing device.

The server uses the completion status 205 and the mapping information 203 to calculate the starting point of viewing the complete file 209. This information is also transmitted to the viewing device 100, perhaps as part of the download or perhaps in a separate message.

Thus when the viewing device 100 displays the complete file 104, it does so at the point where viewing the sample file left off.

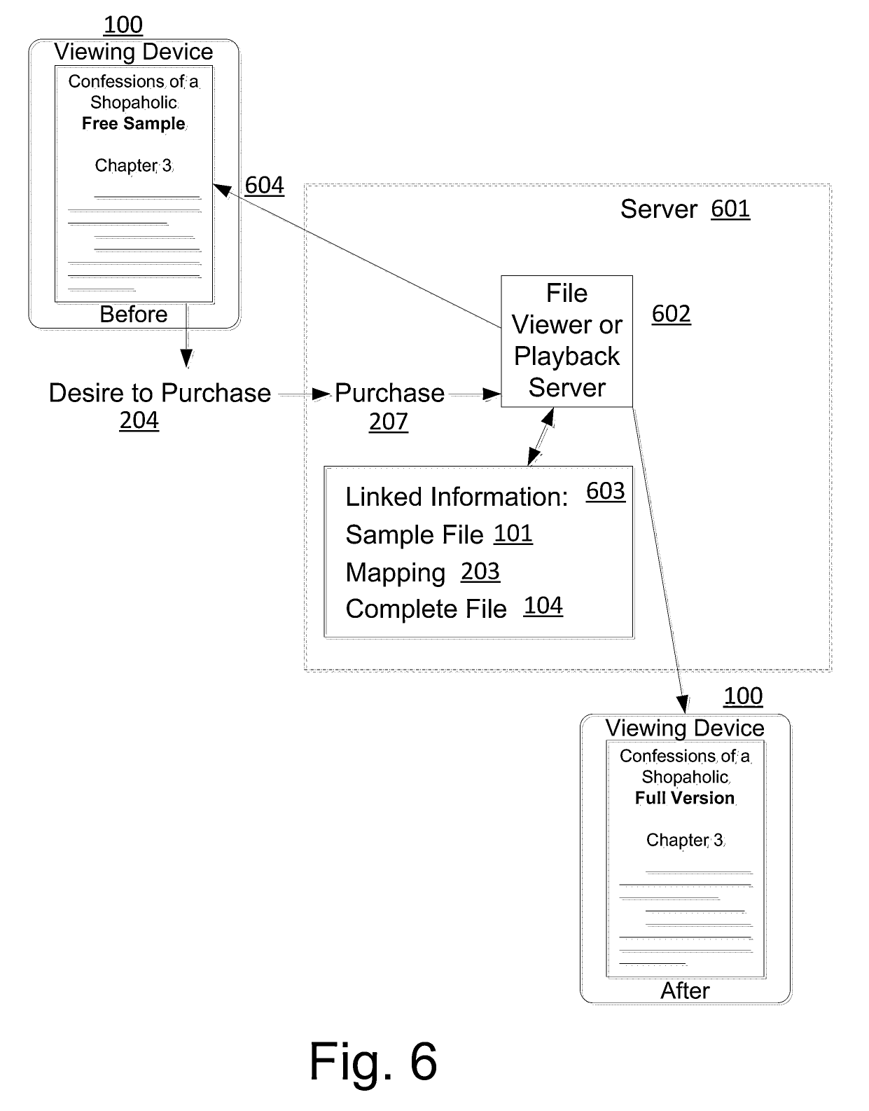

Another detailed example is illustrated in FIG. 6.

The viewing device 100 is connected to a server 601. The server hosts a service 602 that is used to view or play back files. Thus the viewer only displays a small portion 604 of the sample file at a time, and the service 602 is “aware” of the status of viewing.

This arrangement is often used when the file is prohibitively large, when the Internet connection is relatively slow (so that a complete download would take too long), or when storage on the viewing device is relatively small. A common example is a video hosted by YouTube. Another is viewing of a video-on-demand (VoD) movie by a cable set-top box.

The service 602 has access to a linked set of information 603 that includes the sample file 101, a mapping function 203 between the sample and complete file, and the complete file 104.

At some point the consumer decides to “purchase” the complete version. The desire to purchase the complete version 204 is expressed via the viewing device's user interface. The server 601 authorizes the purchase 207. It uses the linked information to identify the complete file 104 and the mapping information 203. It uses the mapping information 203 and the knowledge of the completion status maintained by the service 602 to calculate a new starting point for the complete file.

The service 602 then switches from transmitting portions of the sample file 101 to transmitting portions of the complete file 104 at the new starting point. The viewing device 100 continues to display the transmitted information, which appears to the consumer to switch from the sample file 101 to the complete file 104 at the point at which viewing of the sample file 101 left off.

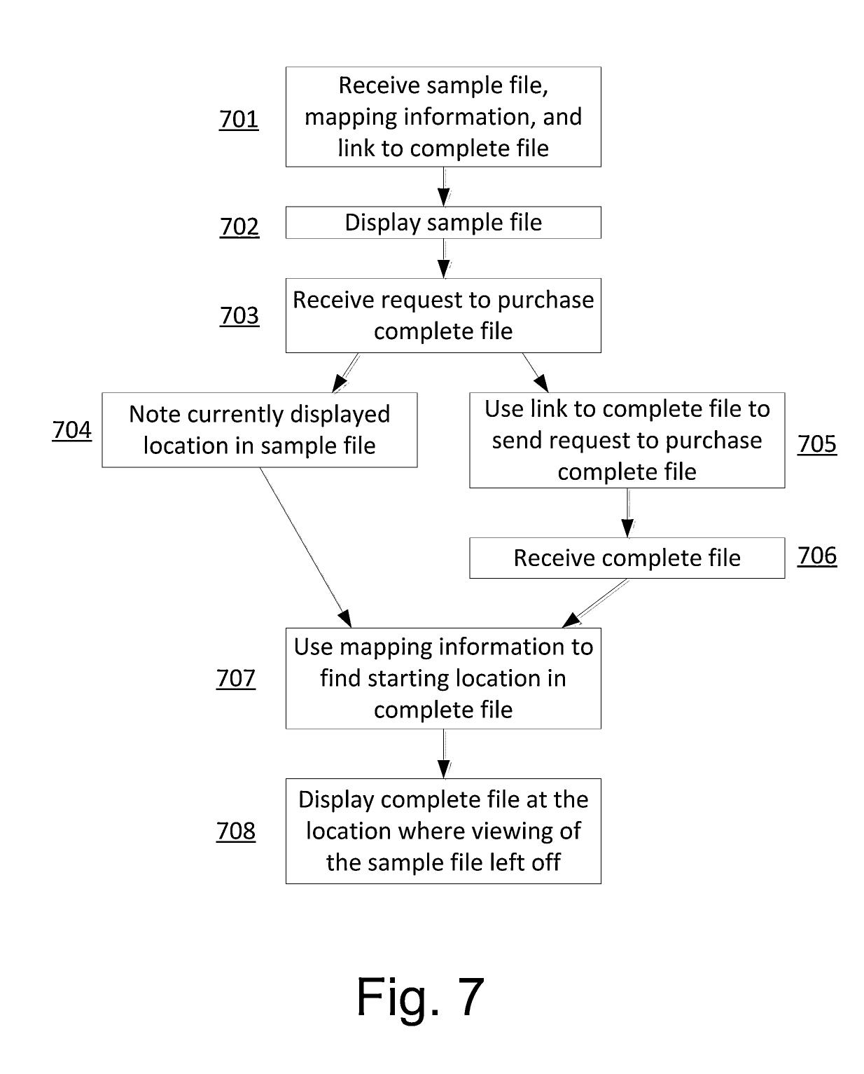

An example of an algorithm, method, or process used by a viewing device is illustrated in FIG. 7. The algorithm might be implemented as executable software, a downloadable script, executable content, a hardware state machine, or custom logic.

In step 701, a viewing device receives a sample file, mapping information and a link to a complete file. The sample file might be a video file, audio file, or book, for example. It can receive the file via a network connection or via removable storage. The link might be a URL, stock number, ISBN, or other information that uniquely identifies the complete file corresponding to the sample file. The mapping information might be an algorithm, an executable function, a lookup table, or an indication of equality. (That is, the mapping information might be the recognition that the location in the complete file is the same as the location in the sample file.)

In step 702, it displays the sample file. For example, if it is an audio file it plays audio.

In step 703, the viewing device receives a request from the user to purchase the complete file.

In step 704, the viewing device notes the currently displayed location in the sample file. The location information might be expressed in terms of time, page number, chapter number, line number, or file offset, for example.

In step 705, the viewing device uses the link to send a request to purchase the complete file. The request is sent via a network interface.

In step 706, the viewing device receives the complete file.

In step 707, the viewing device uses the mapping information and the noted current display location to find or calculate the starting location in the complete file.

In step 708, the viewing device displays the complete file at the location where viewing of the sample file left off.

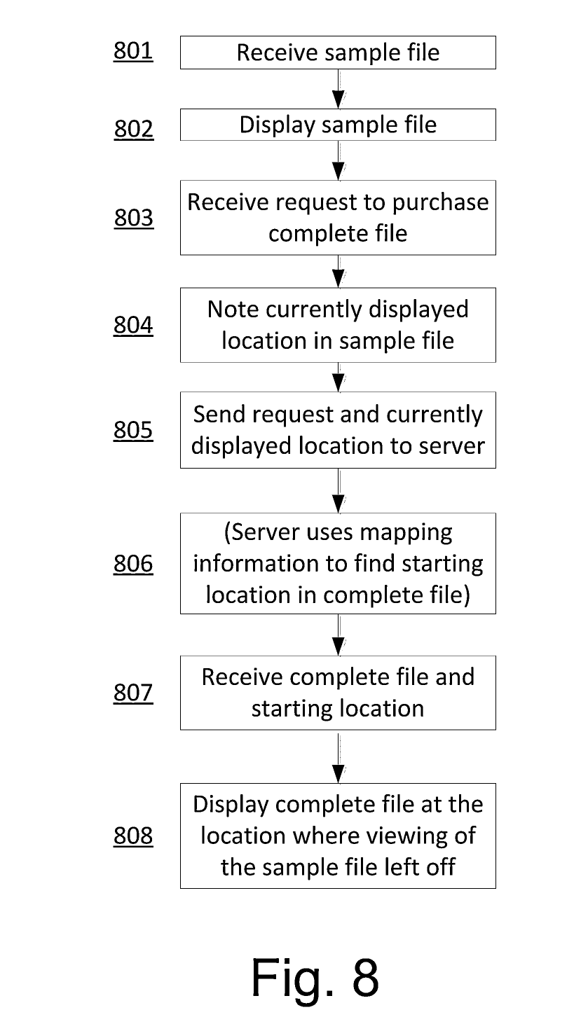

Another example of an algorithm used by a viewing device, in concert with a server, is illustrated in FIG. 8.

In step 801, a viewing device receives a sample file.

In step 802, it displays the sample file.

In step 803, the viewing device receives a request from the user to purchase the complete file.

In step 804, the viewing device notes the currently displayed location in the sample file.

In step 805, the viewing device sends a request to purchase the complete file along with the currently displayed location. The request is sent via a network interface.

In step 806, the server uses the currently displayed location to calculate the starting point in the complete file.

In step 807, the viewing device receives the complete file and an indication of the starting location.

In step 808, the viewing device displays the complete file at the location where viewing of the sample file left off.

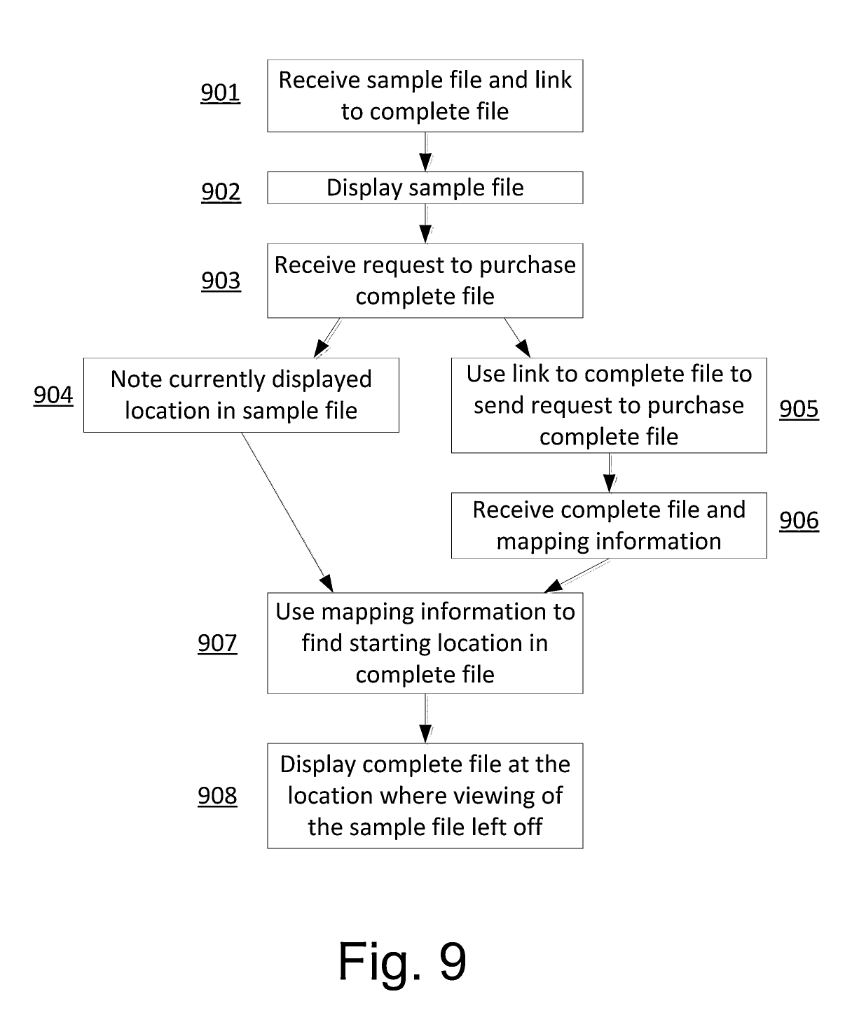

Another example of an algorithm used by a viewing device is illustrated in FIG. 9.

In step 901, a viewing device receives a sample file and a link to a complete file.

In step 902, it displays the sample file.

In step 903, the viewing device receives a request from the user to purchase the complete file.

In step 904, the viewing device notes the currently displayed location in the sample file.

In step 905, the viewing device uses the link to send a request to purchase the complete file. The request is sent via a network interface.

In step 906, the viewing device receives the complete file along with a set of mapping information that describes how to map the currently displayed location in the sample file to a location in the complete file.

In step 907, the viewing device uses the mapping information and the noted current display location to find or calculate the starting location in the complete file.

In step 908, the viewing device displays the complete file at the location where viewing of the sample file left off.

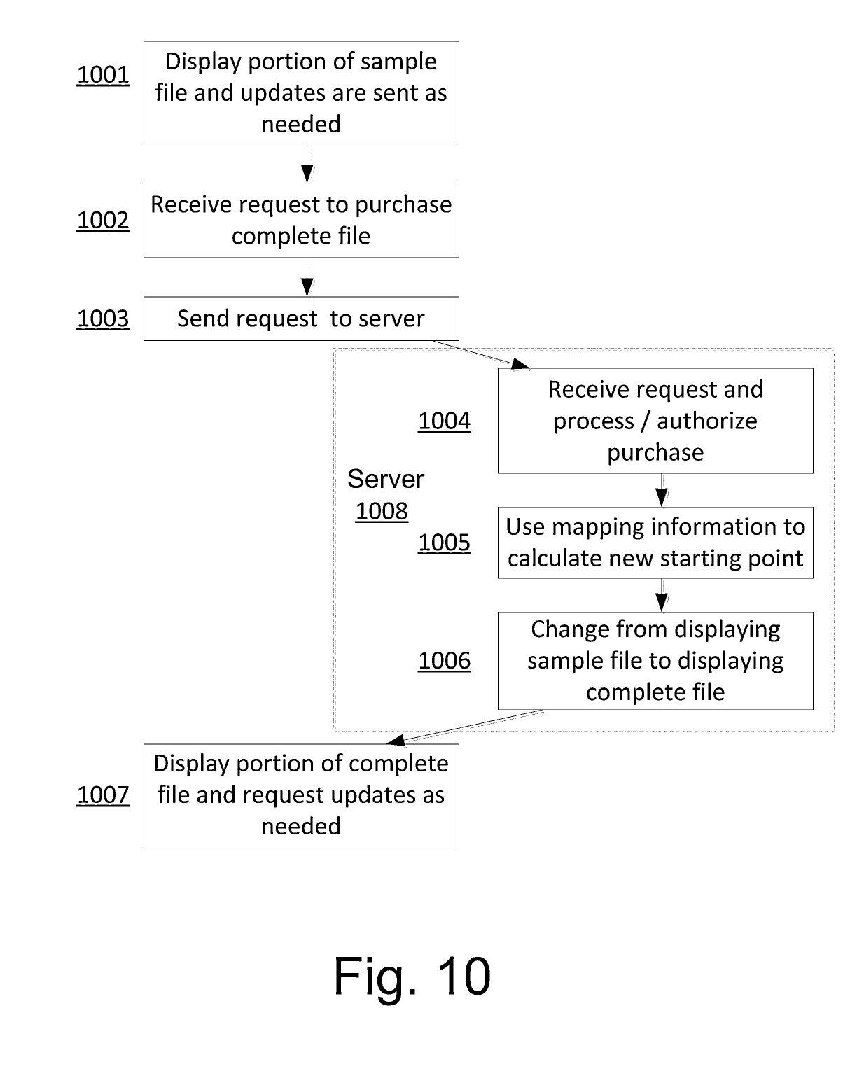

Another example of an algorithm used by a viewing device, in concert with a server, is illustrated in FIG. 10. Note that the server has on hand a sample file, a complete file, and information that serves to map a location in the sample file to a location in the complete file.

In step 1001, a viewing device displays a portion of a sample file. (For example, the file may be prohibitively large or the storage size of the viewing device might be relatively small.) The viewing device may request viewing updates from a file server as the file is being displayed. Because only a small amount of the file is transferred at a time, and because the viewing device must request updates, the server tracks the viewing status of the sample file. Alternatively, transfer of the sample file may occur continuously and/or at a fixed rate, and so the server tracks the viewing status of the file.

In step 1002, the viewing device receives a request from the user to purchase the complete file.

In step 1003, the viewing device sends a request to the server to purchase the complete file.

In step 1004, the server receives the request and processes and/or authorizes the purchase.

In step 1005, the server uses the mapping information and its knowledge of the viewing status of the file to calculate the starting point of the complete file.

In step 1006, the server switches from transferring portions of the sample file to transferring portions of the complete file.

In step 1007, the viewing device displays the complete file at the location where viewing of the sample file left off.

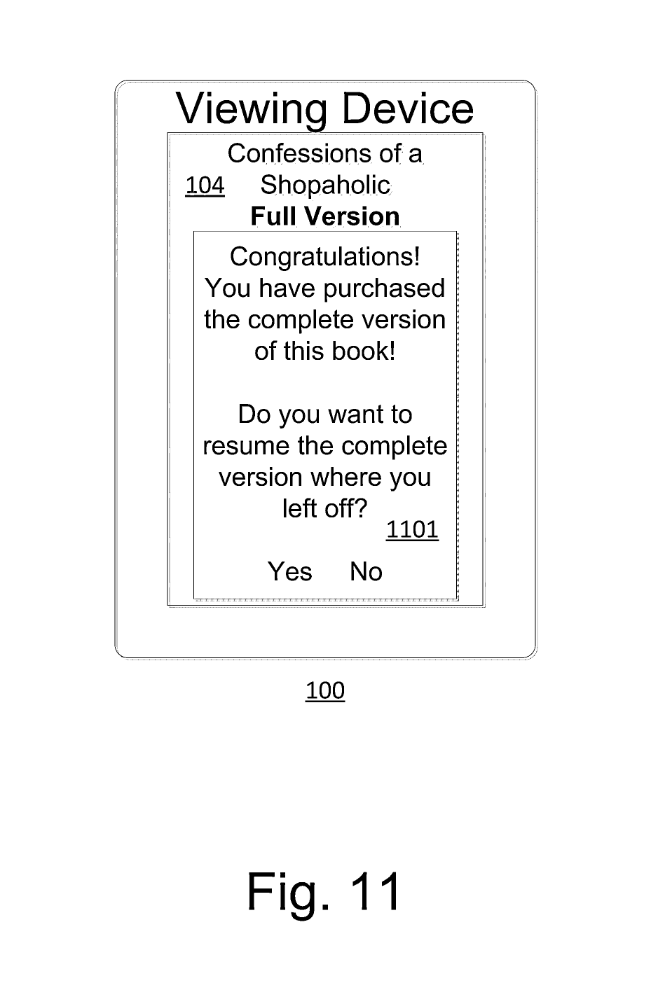

FIG. 11 illustrates an optional step in the process of switching to view the complete file. As shown in the figure, the viewing device 100, after receiving the complete file 104, might post an interactive screen 1101 asking the consumer whether to begin viewing of the complete file at the beginning of the file or at the point where the sample file left off. In lieu of a screen, the viewing device might present the option via the viewing device's native user interface. The option allows consumers who wish so to start the complete file over again. This optional step may be applied to all of the embodiments of the invention.

The embodiments and examples described above are presented to illustrate and explain the present invention and to enable persons of ordinary skill in the art to make and use the invention. However, such persons will recognize that the embodiments and examples are for illustration and example only, and are not intended to be exhaustive or to limit the scope and spirit of the invention or of the following claims.

What is claimed is:

1. A method for starting the playback or viewing of a second electronic media file at the point where the viewing of a first electronic media file left off, said method consisting of the steps of:
Displaying at least part of a first electronic media file
Receiving a request to display instead a second electronic media file
Noting the point where the first electronic media file is being displayed
Transmitting the request to display instead a second electronic media file
Receiving at least part of a second electronic media file
Displaying the second electronic media file at the point where the first electronic media file was being displayed

2. The method of claim 1, wherein the said request to display instead a second electronic media file is a request to purchase the second electronic media file

3. The method of claim 1, wherein the said first electronic media file is at least one of an abbreviated, reduced-cost, or free version of the second electronic media file

4. The method of claim 1, wherein the point where the electronic media file is being displayed is at least one of a page number, line number, time offset, or file offset

5. The method of claim 1, wherein the said step of displaying the second electronic media file at the point where the first electronic media file was being displayed is preceded by a step of asking whether to display the second file at its beginning or at the point where the first file was being displayed

6. The method of claim 1, wherein the point for displaying the second media file is inferred from the point where the first media file was being displayed and from a mapping function that maps from the point in the first media file to a point in the second media file

7. The method of claim 6, wherein the mapping function is at least one of an algorithm, a function, a mathematical expression, a lookup table, a statement of equality, or an inference of equality

8. The method of claim 6, wherein the mapping function is included with the first media file

9. The method of claim 6, wherein the mapping function is included with the second media file

10. The method of claim 6, wherein the mapping function is kept at a server

11. The method of claim 1, wherein the point at which the first electronic media file is being displayed is transmitted to a server

12. The method of claim 1, wherein the point at which the first electronic media file is being displayed is not transmitted

13. The method of claim 1, wherein the request to display instead a second electronic media file is transmitted to a server

14. The method of claim 13, wherein the server transmits the second electronic media file responsive to the request to display instead a second electronic media file

15. The method of claim 1, wherein the said step of noting the point where the first electronic media file is being displayed occurs when the said request to display instead a second electronic media file is received

16. The method of claim 1, wherein the said step of noting the point where the first electronic media file is being displayed occurs at a server

17. The method of claim 1, wherein the display of the first electronic media file occurs on a different device from the display of the second electronic media file

18. The method of claim 1, wherein the display of the first electronic media file occurs on the same device as the display of the second electronic media file

19. The method of claim 1, wherein the server only transmits that portion of the first or second media file that is being displayed

20. The method of claim 1, wherein the said step of transmitting the request occurs locally

21. The method of claim 20, wherein the step of receiving the second electronic media file occurs temporally before the step of receiving a request to display instead a second electronic media file

22. The method of claim 20, wherein the step of transmitting the request causes the second electronic media file to become viewable

23. The method of claim 1, wherein an electronic media file is one of a book, movie, video, television program, article, audio recording, or musical work.

24. The method of claim 1, wherein displaying an electronic media file occurs on a viewing device

25. A viewing device that starts the playback or viewing of a second electronic media file at the point where the viewing of a first electronic media file left off, said viewing device comprising:
A display that can present a first electronic media file to a user
A user interface that can receive a request to display instead a second electronic media file
Logic that can note the point where the first electronic media file is being displayed
A transmitter that can send the request to display instead a second electronic media file
A receiver that can receive a second electronic media file
Logic that can determine the point where to begin viewing the second electronic media file
Said display that can present instead a second electronic media file to a user

26. The viewing device of claim 25, wherein the said request to display instead a second electronic media file is a request to purchase the second electronic media file

27. The viewing device of claim 25, wherein the said first electronic media file is at least one of an abbreviated, reduced-cost, or free version of the second electronic media file

28. The viewing device of claim 25, wherein the point where the first electronic media file is being displayed is at least one of a page number, line number, time offset, or file offset

29. The viewing device of claim 25, wherein presenting instead the second electronic media file is preceded by asking whether to display the second file at its beginning or at the point where the first file was being displayed

30. The viewing device of claim 25, wherein the point for beginning the viewing of the second media file is inferred from the point where the first media file was being displayed and from a mapping function that maps from the point in the first media file to a point in the second media file

31. The viewing device of claim 30, wherein the mapping function is at least one of an algorithm, a function, a mathematical expression, a lookup table, a statement of equality, or an inference of equality

32. The viewing device of claim 30, wherein the mapping function is included with the first media file

33. The viewing device of claim 30, wherein the mapping function is included with the second media file

34. The viewing device of claim 30, wherein the mapping function is kept at a server

35. The viewing device of claim 25, wherein the transmitter transmits the point at which the first electronic media file is being displayed

36. The viewing device of claim 25, wherein the transmitter does not transmit the point at which the first electronic media file is being displayed

37. The viewing device of claim 25, wherein the transmitter transmits to a server

38. The viewing device of claim 37, wherein the server transmits the second electronic media file responsive to the request to display instead a second electronic media file

39. The viewing device of claim 25, wherein the logic that notes the point where the first electronic media file is being displayed acts when the said request to display instead a second electronic media file is received

40. The viewing device of claim 25, wherein the server only transmits that portion of the first or second media file that is being displayed

41. The viewing device of claim 25, wherein the said transmitter and receiver act locally on the viewing device

42. The viewing device of claim 41, wherein the receiver received the second electronic media file temporally before the user interface received the request to display instead a second electronic media file

43. The viewing device of claim 42, wherein the step of transmitting the request causes the second electronic media file to become viewable

44. The viewing device of claim 25, wherein an electronic media file is one of a book, movie, video, television program, article, audio recording, or musical work.

45. The display of claim 25, wherein the display is at least one of a video display, a speaker, speakers, headphones, a video output, or an audio output.
